(19) United States
(12) Patent Application Publication
(10) Pub. No.: US 2011/0277727 A1
(43) Pub. Date: Nov. 17, 2011

(54) ENGINE INCLUDING FUEL INJECTOR SPRAY PATTERN

(75) Inventors: James D. Hay, Milford, MI (US); Scott Halsall, Warren, MI (US)

(73) Assignee: GM GLOBAL TECHNOLOGY OPERATIONS, INC., Detroit, MI (US)

(21) Appl. No.: 12/874,369

(22) Filed: Sep. 2, 2010

Related U.S. Application Data
(60) Provisional application No. 61/345,362, filed on May 17, 2010.

(51) Int. Cl. F02B 5/00

(52) U.S. Cl. 123/305

(57) ABSTRACT

An engine assembly may include an engine structure defining a combustion chamber, a spark plug extending into a central region of the combustion chamber and a fuel injector in communication with the central region of the combustion chamber. The fuel injector may define a C-shaped fuel spray emanating from the central region of the combustion chamber and spaced from the spark plug.

### CROSS-REFERENCE TO RELATED APPLICATIONS

This application claims the benefit of U.S. Provisional Application No. 61/345,362, filed on May 17, 2010. The entire disclosure of the above application is incorporated herein by reference.

### FIELD

The present disclosure relates to engine fuel systems, and more specifically to engine fuel injector spray patterns.

### BACKGROUND

This section provides background information related to the present disclosure which is not necessarily prior art.

Internal combustion engines may combust a mixture of air and fuel in cylinders and thereby produce drive torque. The location and spray pattern of fuel injection into the engine combustion chamber may affect engine performance.

### SUMMARY

An engine assembly may include an engine structure defining a combustion chamber, a spark plug extending into a central region of the combustion chamber and a fuel injector in communication with the central region of the combustion chamber. The fuel injector may define a C-shaped fuel spray emanating from the central region of the combustion chamber and spaced from the spark plug.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure; and

FIG. 2 is a schematic top plan illustration of the cylinder bore and fuel spray of the engine assembly of FIG. 1;

FIG. 3 is a schematic perspective illustration of the fuel spray shown in FIG. 1; and

FIG. 4 is an additional schematic perspective illustration of the fuel spray shown in FIG. 1.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

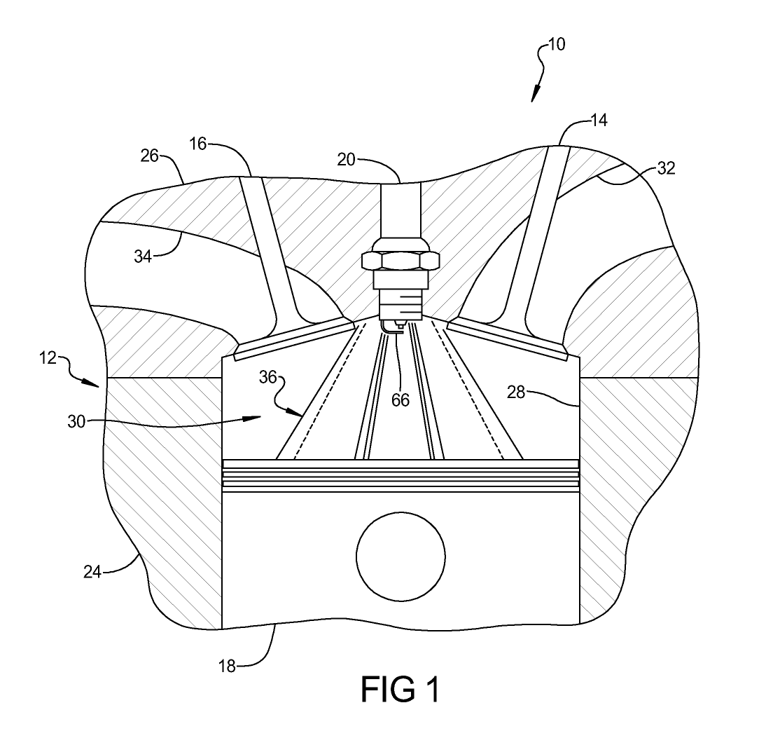

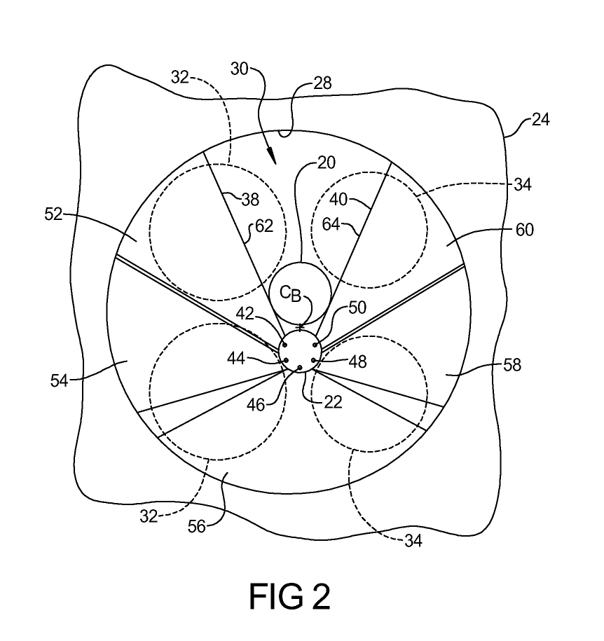

An engine assembly 10 is schematically illustrated in FIGS. 1 and 2 and may include an engine structure 12, intake and exhaust valves 14, 16, a piston 18, a spark plug 20 and a fuel injector 22. The engine structure 12 may include an engine block 24 and a cylinder head 26 fixed to the engine block 24. The piston 18 may be disposed in a cylinder bore 28 defined in the engine block 24. The engine structure 12 may define a combustion chamber 30. More specifically, the engine block 24, the cylinder head 26 and the piston 18 may cooperate to define the combustion chamber 30. The cylinder head 26 may define intake and exhaust ports 32, 34 in communication with the combustion chamber 30. It is understood that the present teachings apply to any number of piston-cylinder arrangements and a variety of engine configurations including, but not limited to, V-engines, inline engines, and horizontally opposed engines, as well as both overhead cam and cam-in-block configurations.

The spark plug 20 and the fuel injector 22 may be located in the cylinder head 26 and may be in direct communication with the combustion chamber 30. A first half of the combustion chamber 30 may define an intake side of the combustion chamber 30 and a second half of the combustion chamber 30 may define an exhaust side of the combustion chamber 30. The spark plug 20 and the fuel injector 22 may be located between the intake side and the exhaust side of the combustion chamber 30.

In the present non-limiting example, the spark plug 20 and the fuel injector 22 may be centrally located in the combustion chamber 30 relative to an outer radial perimeter defined by the cylinder bore 28, forming a central direct injection configuration. More specifically, the spark plug 20 may extend into a central region of the combustion chamber 30 and the fuel injector 22 may be in communication with the central region of the combustion chamber 30. The spark plug 20 and the fuel injector 22 may each be radially offset from a center (C_{B}) of the combustion chamber 30 in directions opposite one another.

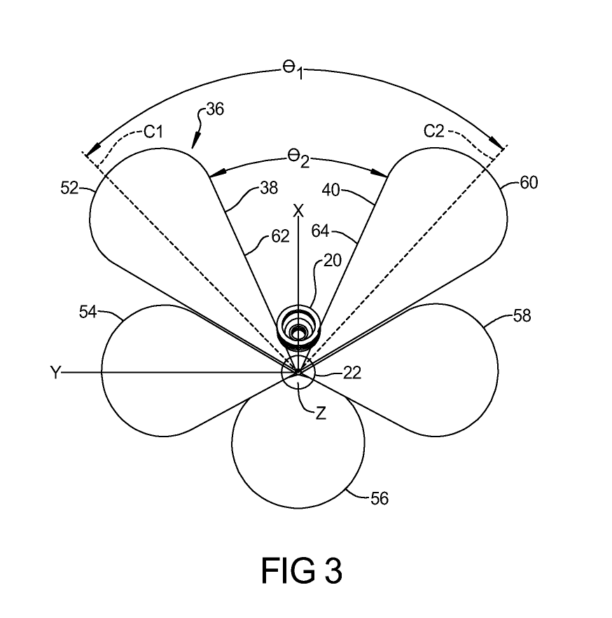

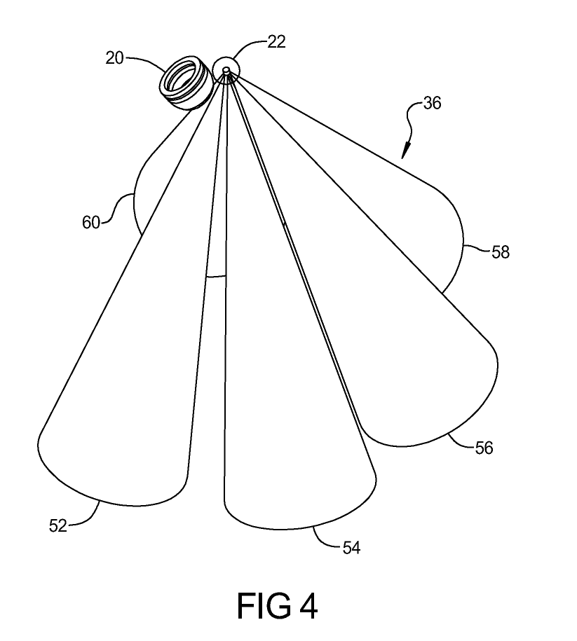

With additional reference to FIGS. 3 and 4, the fuel injector 22 may be in communication with a pressurized fuel source (not shown) and may define a fuel spray 36 spaced from the spark plug 20. In the present non-limiting example, the fuel injector 22 defines a C-shaped fuel spray 36 emanating from the central region of the combustion chamber 30. The C-shaped fuel spray 36 may be spaced from the spark plug 20. More specifically, the C-shaped fuel spray 36 may define ends 38, 40 located on opposite sides of the spark plug 20.

The fuel spray 36 may be formed by openings (outlets) 42, 44, 46, 48, 50 in the fuel injector 22 arranged in a C-pattern (schematically illustrated in FIG. 2). The C-shaped fuel spray 36 may be formed by a series of individual plumes 52, 54, 56, 58, 60 associated with each of the openings 42, 44, 46, 48, 50. The plumes 52, 54, 56, 58, 60 may include an initial plume 52, a last plume 60, and intermediate plumes 54, 56, 58 defined between the initial plume 52 and the last plume 60. The intermediate plumes 54, 56, 58 may include a first intermediate plume 54, a central plume 56, and a second intermediate plume 58. The first intermediate plume 54 may be located between the initial plume 52 and the central plume 56 and the second intermediate plume 58 may be located between the central plume 56 and the last plume 60. While illustrated as five plumes emanating from five openings, it is understood the present disclosure applies equally to arrangements including more or less plumes and/or openings.

The initial plume 52 and last plume 60 may be located on opposite sides of the spark plug 20. The initial plume 52 may be located on a first side of the spark plug 20 and the last plume 60 may be located on a second side of the spark plug 20 opposite the first side. More specifically, the initial plume 52 may define an outer periphery 62 adjacent the first side of the spark plug 20 and the last plume 60 may define an outer periphery 64 adjacent the second side of the spark plug 20. The portion of the outer periphery 62 of the initial plume 52 directly adjacent the spark plug 20 may be spaced radially from the first side of the spark plug 20 and the portion of the outer periphery 64 of the last plume 60 directly adjacent the spark plug 20 may be spaced radially from the second side of the spark plug 20. More specifically, the outer peripheries 62, 64 may be spaced radially from the electrode 66 of the spark plug 20. The initial plume 52 and the last plume 60 may extend radially beyond the spark plug 20 at a location axially beyond the spark plug 20. The central plume 56 may extend radially outward from the spark plug 20 (i.e., away from the spark plug 20).

By way of non-limiting example, a centerline (C1) of the initial plume 52 may be disposed at a first angle (θ₁) relative to a centerline (C2) of the last plume 60. The first angle (θ₁) may be at least thirty degrees. The outer peripheries 62, 64 may define a second angle (θ₂) therebetween. The second angle (θ₂) may be at least twenty degrees. A non-limiting example of the fuel spray 36 is illustrated in FIG. 3 and summarized in Table 1 below.

TABLE 1

| | Diameter | Cone Angle | X | Y |
|---|---|---|---|---|
| | (mm) | (degrees) | (mm) | (mm) |
| Plume (56) | 5.59 | 25.91 | −24.28 | 0.00 |
| Plume (54) | 5.19 | 22.70 | −8.70 | 29.87 |
| Plume (52) | 5.34 | 21.20 | 28.63 | 33.80 |
| Plume (60) | 5.33 | 20.70 | 28.63 | −33.80 |
| Plume (58) | 5.40 | 23.71 | −8.70 | −29.87 |

The plume diameters in Table 1 are at location along the z-axis of 50 millimeters (mm). The z-axis is shown extending into the page in FIG. 3 (i.e., into the cylinder bore 28 and combustion chamber 30 and perpendicular to the x- and y-axes). The cone angle in Table 1 defines an exemplary included angle of the plumes. It is understood that the present disclosure applies to a variety of configurations and is not limited to the specific plume geometry of Table 1.

A first included angle (cone angle) is defined by the initial plume 52 and a second included angle is defined by the last plume 60. The central plume 56 may define a third included angle greater than the first and second included angles. Each of the intermediate plumes 54, 56, 58 may define an included angle greater than the first included angle and the second included angle. More specifically, the first intermediate plume 54 may define a fourth included angle and the second intermediate plume 58 may define a fifth included angle. The third included angle may be greater than the fourth and fifth included angles, the fourth included angle may be greater than the first included angle, and the fifth included angle may be greater than the second included angle.

As seen in the non-limiting example in Table 1, each of the first, second, third, fourth, and fifth included angles may be greater than twenty degrees. Additionally, as seen in the non-limiting example in Table 1, each of the initial, intermediate, and last plumes 52, 54, 56, 58, 60 may define a plume diameter greater than five millimeters at a location fifty millimeters into the combustion chamber 30.

What is claimed is:

1. An engine assembly comprising:
an engine structure defining a combustion chamber;
a spark plug extending into a central region of the combustion chamber; and
a fuel injector in communication with a central region of the combustion chamber and defining a C-shaped fuel spray emanating from the central region and spaced from the spark plug.

2. The engine assembly of claim 1, wherein the C-shaped fuel spray is formed by a series of individual plumes including an initial plume located on a first side of the spark plug and a last plume located on a second side of the spark plug opposite the first side.

3. The engine assembly of claim 2, wherein an angle defined between an outer periphery of the initial plume adjacent the first side of the spark plug and an outer periphery of the last plume adjacent the second side of the spark plug is at least twenty degrees.

4. The engine assembly of claim 2, wherein an angle defined between a centerline of the initial plume and a centerline of the last plume is at least thirty degrees.

5. The engine assembly of claim 2, wherein intermediate plumes are defined between the initial plume and the last plume and each of the intermediate plumes defines an included angle greater than a first included angle defined by the initial plume and a second included angle defined by the last plume.

6. The engine assembly of claim 5, wherein the first and second included angles and the included angle of each of the intermediate plumes are greater than twenty degrees.

7. The engine assembly of claim 2, wherein intermediate plumes are defined between the initial plume and the last plume and each of the initial, last, and intermediate plumes define a plume diameter greater than five millimeters at a location fifty millimeters into the combustion chamber.

8. The engine assembly of claim 2, wherein the initial plume and the last plume extend radially beyond the spark plug at a location axially beyond the spark plug.

9. The engine assembly of claim 1, wherein the spark plug and the fuel injector are each radially offset from a center of a the combustion chamber in directions opposite one another.

10. The engine assembly of claim 9, wherein a first half of the combustion chamber defines an intake side of the combustion chamber and a second half of the combustion chamber defines an exhaust side of the combustion chamber, the spark plug and the fuel injector being located between the intake side and the exhaust side.

11. An engine assembly comprising:
an engine structure defining a combustion chamber;
a spark plug extending into a central region of the combustion chamber; and
a fuel injector in communication with a central region of the combustion chamber and defining a C-shaped fuel spray emanating from the central region, spaced from the spark plug, and formed by a series of individual plumes including an initial plume located on a first side of the spark plug, a last plume located on a second side of the spark plug opposite the first side, and a central plume located between the initial plume and the last plume.

12. The engine assembly of claim 11, wherein the central plume extends radially outward from the spark plug.

13. The engine assembly of claim 12, wherein the initial plume defines a first included angle, the last plume defines a second included angle, and the central plume defines a third included angle greater than the first and second included angles.

14. The engine assembly of claim 13, wherein the C-shaped fuel spray includes a first intermediate plume located between the initial plume and the central plume and a second intermediate plume located between the central plume and the last plume.

15. The engine assembly of claim 14, wherein the first intermediate plume defines a fourth included angle and the second intermediate plume defines a fifth included angle, the third included angle being greater than the fourth and fifth included angles.

16. The engine assembly of claim 15, wherein the fourth included angle is greater than the first included angle.

17. The engine assembly of claim 16, wherein the fifth included angle is greater than the second included angle.

18. The engine assembly of claim 17, wherein each of the first, second, third, fourth and fifth included angles are each greater than twenty degrees.

19. The engine assembly of claim 18, wherein an angle defined between an outer periphery of the initial plume adjacent the first side of the spark plug and an outer periphery of the last plume adjacent the second side of the spark plug is at least twenty degrees.

20. The engine assembly of claim 18, wherein an angle defined between a centerline of the initial plume and a centerline of the last plume is at least thirty degrees.
